(19) United States
(12) Patent Application Publication
(10) Pub. No.: US 2011/0232533 A1
(43) Pub. Date: Sep. 29, 2011

(54) METHOD FOR PRODUCING CALCIUM SILICATE-BASED BONE CEMENT

(75) Inventor: SHINN JYH DING, TAICHUNG CITY (TW)

(73) Assignee: CHUNG SHAN MEDICAL UNIVERSITY, TAICHUNG CITY (TW)

(21) Appl. No.: 13/111,209

(22) Filed: May 19, 2011

Related U.S. Application Data
(62) Division of application No. 12/025,701, filed on Feb. 4, 2008, now abandoned.

(51) Int. Cl. C04B 28/00

(52) U.S. Cl. 106/816; 106/638

(57) ABSTRACT

One aspect of the present invention provides a method for producing calcium silicate-based bone cement, including the steps of mixing calcium salt with silicohydrides to form a first mixture; processing the first mixture with a sol-gel process to form a second mixture; heating the second mixture to form a dried mixture; grinding the second mixture into powder; and adding the powder to water or phosphate solution.

### CROSS REFERENCE TO RELATED APPLICATIONS

This application is a divisional of Ser. No. 12/025,701, filed on Feb. 4, 2008.

### BACKGROUND OF THE INVENTION

1. Technical Field

The present invention relates to bone cement, and more particularly to calcium silicate-based bone cement.

2. Background

Bone defects occur in a wide variety of clinical situations, and their reconstruction to provide mechanical integrity to the skeleton is a necessary step in the patient's rehabilitation. A direct chemical bond between the bone and the bone repair materials may be desirable. Several materials, such as glass-ionomer cement, bioactive glass cement, and calcium phosphate cement that satisfy this requirement have attracted investigation as a suitable bone fixation/repair material due to their bioactivity and mechanical properties. Kokubo's group reported a bioactive bone cement composed of MgO—CaO—SiO₂—P₂O₅—CaF₂ glass powder and bisphenol-a-glycidyl methacrylate (Bis-GMA) resin (Tamura J, Kawanabe K, Kobayashi M, Nakamura T, Kokubo T, Yoshihara S, Shibuya T., Mechanical and biological properties of two types of bioactive bone cements containing: MgO—CaO—SiO₂—P₂O₅—CaF₂ glass and glass-ceramic powder, J Biomed Mater Res 1996; 30:85-94). Brown and Chow developed a calcium phosphate cement comprised of a mixture of particles of tetracalcium phosphate (Ca₄(PO₄)₂O) and dicalcium phosphate anhydrous (CaHPO₄), which is mixed with water to form a paste that converts in situ to hydroxyapatite (Brown W E, Chow L C. Dental restorative cement pastes. U.S. Pat. No. 4,518,430, 1998).

In the 1970s, Carlisle reported that silicon (Si) was an important trace element in an early stage of bone formation as a result of earlier in vitro and in vivo studies (Carlisle E M, Silicon: a possible factor in bone calcification. Science 1970; 167:279-280). Silicon increases directly with calcium at relatively low calcium concentrations and falls below the detection limit at compositions approaching hydroxyapatite. The soluble form of Si may stimulate collagen type I synthesis and osteoblastic differentiation in human osteoblast-like cells (Reffitt D M, Ogston N, Jygdaohsingh R. Orthosilicic acid stimulates collagen type I synthesis and osteoblastic differentiation in human osteoblast-like cells in vitro. Bone 2003; 32:127-135). Klein et al. found that more stable silica gels treated at 900 and 1000° C. showed some bone bonding, while degraded gels sintering at the lower temperatures of 400 and 600° C. evoked a high cellular reaction of giant cells and lymphocytes (Klein CPAT, Pangjian Li, de Blieck-Hogervorst JMA, de Groot K. Effect of sintering temperature on silica gels and their bone bonding ability. Biomaterials 1995; 16:715-719). Several attempts have been made to prepare Si-containing bioactive materials such as bioactive glass and silicon-substituted hydroxyapatite (HA) to create new materials or improve the performance such as bioactivity and mechanical properties of bulk HA. Gibson et al. developed silicon-substituted hydroxyapatite by incorporating a small amount of silicon (0.4 wt %) into the structure of hydroxyapatite via an aqueous precipitation reaction (Gibson I R, Best S M, Bonfield W. Chemical characterization of silicon-substituted hydroxyapatite. J Biomed Mater Res 1999; 44:422-428). Silicate-based materials may be promising for use in the reconstruction of frontal sinus and spine, augmentation of craniofacial skeletal defects and osteoporosis, endodontics, and repair of periodontal bone defects.

The sol-gel-prepared materials are transformed to ceramics by heating at relatively low temperatures and have better chemical and structural homogeneity than those obtained by conventional glass melting or ceramic powder methods. It has been reported that materials prepared by a sol-gel process are more bioactive than the materials of the same compositions prepared by other methods (Li P, de Groot K. Better bioactive ceramics through sol-gel process. J Sol-Gel Sci Technol 1994; 2:797-806). Certain hydroxyl groups such as Si—OH remaining in the sol-gel-prepared materials are assumed to promote hydroxyapatite formation by providing sites for calcium phosphate nucleation (Peltola T, Jokinen M, Rahiala H, Levänen E, Rosenholm J B, Kangasniemi I, Yli-Urpo A. Calcium phosphate formation on porous sol-gel-derived SiO₂ and CaO—P₂O₅—SiO₂ substrates in vitro. J Biomed Mater Res 1999; 44:12-21). Izquierdo-Barba et al. synthesized a bioactive glass with a composition of SiO₂ 80% and CaO 20% (in mol %) by sol-gel method and opened up new researches in the CaO—SiO₂ system (Izquierdo-Barba I, Salinas A J, Vallet-Regí M. In vitro calcium phosphate layer formation on sol-gel glasses of the CaO—SiO₂ system. J Biomed Mater Res 1999; 47:243-250). The same research group also found that the rate of apatite formation on the SiO₂—CaO glass with lower SiO₂ (50-70% in mol) is greater than that on glasses with higher SiO₂ (80-90% in mol) when soaked in a simulated body fluid (Martínez A, Izquierdo-Barba I, Vallet-Regí M. Bioactivity of a CaO—SiO₂ binary glasses system. Chem Mater 2000; 12:3080-3088). In studies by Chang' group (Gou Z, Chang J. Synthesis and in vitro bioactivity of dicalcium silicate powders. J Eur Ceram Soc 2004; 24:93-99; Zhao W, Chang J. Sol-gel synthesis and in vitro bioactivity of tricalcium silicate powders. Mater Lett 2004; 58:2350-2353), sol-gel derived dicalcium silicate and tricalcium silicate powders could form a carbonate-containing hydroxyapatite layer on the surface when soaked in simulated body fluid. With the two calcium silicate powders, they can be mixed with water to produce a calcium silicate cement with the initial setting time of greater than one hour, whereas the apatite precipitation needed several days in simulated body fluid (Zhao W, Wang J, Zhai W, Wang Z, Chang J. The self-setting properties and in vitro bioactivity of tricalcium silicate. Biomaterials 2005; 26:6113-6121; Gou Z, Chang J, Zhai W, Wang J. Study on the self-setting property and the in vitro bioactivity of β-Ca₂SiO₄. J Biomed Mater Res B: Appl Biomater 2005; 73B:244-251).

### SUMMARY

One aspect of the present invention provides a method for producing calcium silicate-based bone cement, comprising the steps of mixing calcium salt with silicohydrides to form a first mixture; processing the first mixture with a sol-gel process to form a second mixture; heating the second mixture to form a dried mixture; grinding the second mixture into powder; and adding the powder to water or phosphate solution.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 illustrates XRD patterns for various as-sintered calcium silicate powders;

FIG. 2 illustrates DTS values of five different calcium silicate-based cements of which solid phases were sintered at a range of temperatures, wherein the ammonium hydrogen phosphate buffer solution was used as a liquid phase;

FIG. 3 illustrates surface SEM micrographs of equilmolar Ca/Si powders sintered at 900° C. after being ground at different times;

FIG. 4 illustrates DTS values of calcium silicate cement with equilmolar Ca/Si ratio of which the solid phase was ground at different times, wherein the ammonium hydrogen phosphate buffer solution was used as a liquid phase;

FIG. 5 illustrates XRD patterns for various hardened cement specimens mixed with ammonium hydrogen phosphate buffer solution;

FIGS. 6A-6C illustrate surface SEM micrographs of the hardened cement specimens with equilmolar Ca/Si before and after immersion for 1 hour in Hanks' solution;

FIG. 7 illustrates DTS values of various cement specimens before and after immersion in Hanks' solution for predetermined periods of time, wherein the ammonium hydrogen phosphate buffer solution was used as a liquid phase;

FIGS. 8A-8D illustrates XRD patterns for various cement specimens before and after immersion in Hanks' solution for predetermined periods of time, wherein the ammonium hydrogen phosphate buffer solution was used as a liquid phase;

FIGS. 9A-9D illustrates SEM micrographs of U2OS cells cultured on cement specimens with equilmolar Ca/Si ratio at various incubation periods, wherein the liquid phase of the cement was ammonium hydrogen phosphate buffer solution; and

FIG. 10 illustrates MTT assay for proliferation of U2OS cultured in the presence of the cement specimens with equilmolar Ca/Si ratio at various incubation periods, wherein the liquid phase of the cement was ammonium hydrogen phosphate buffer solution.

### DETAILED DESCRIPTION

The present invention provides a method for producing calcium silicate-based bone cement, comprising the following steps of mixing calcium salt with silicohydrides to form a first mixture; processing the first mixture with a sol-gel process to form a second mixture; heating the second mixture to form a dried mixture; grinding the second mixture into powder; and adding the powder to water or phosphate solution.

In one embodiment of the present invention, the calcium salt is calcium nitrate and the silicohydride of said method has the following formula:

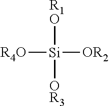

wherein R₁, R₂, R₃ and R₄ are C₁₋₆ alkyl.

In one embodiment of the present invention, the silicohyride of said method has the following formula:

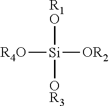

wherein R₁, R₂, R₃ and R₄ are C₂H₅.

In one embodiment of the present invention, said mixture has a molar ratio of calcium to silicon ranging from 10 to 0.1. In one embodiment of the present invention, the mixture has the molar ratio of calcium to silicon ranging from 4 to 0.25.

The sol-gel process of said method comprises the following steps of mixing the calcium and silicon precursors with ethanol and/or dilute nitric acid for 1 to 12 hours; placing the mixture at the temperature of 20 to 80° C. for 1 to 7 days; and drying the mixture at 100 to 150° C.

The heating process of said method comprises the following steps of heating the dried mixture to 700 to 1300° C. at the rate of 1 to 40° C./min; maintaining the mixture at a constant temperature ranging from 700 to 1300° C.; and cooling the mixture to room temperature by air-cooling, water-cooling or fast cooling techniques to obtain calcium silicate powder.

The grinding process comprises the following steps of mixing the calcium silicate powder with alcohol; grinding the powder with a ball miller for 0.5 to 3 days; and drying the powder at 100 to 150° C.

In one embodiment of the present invention, the particle size of the powder ranges from 0.01 to 50 micrometers. In one embodiment of the present invention, the powder is added to water for 10 to 60 seconds and the ratio of water to powder is between 0.3 and 2 mL/g. In one embodiment of the present invention, the ratio of water to powder is between 0.4 and 0.7 mL/g.

In one embodiment of the present invention, the powder is added to phosphate solution for 10 to 60 seconds and the ratio of phosphate solution to powder is between 0.4 and 2 mL/g. In the best embodiment, the ratio of phosphate solution to powder is between 0.5 and 0.8 mL/g.

In one embodiment of the present invention, the anion of the phosphate solution is phosphate radical (PO₄³⁻), monohydric phosphate radical (HPO₄²⁻) or dihydric phosphate radical (H₂PO₄⁻) with a concentration of 0.12 to 5 M, and the cation of the phosphate solution is ammonium, or a member of group I A. Preferably, the cation of the phosphate solution is ammonium, sodium or potassium.

The present invention further provides a mixture comprising calcium silicate-based bone cements having the following characteristics: diametral tensile strength values ranging from 0.9 to 2.9 MPa; and setting times in the range of 3 to 20 minutes.

Furthermore, the mixture can be applied to orthopedic surgery, spine fusion surgery or dental application. It can also serve as replacement bone or tooth material. When applied to humans, it can be orally delivered with an excipient.

### EXAMPLE

The example below is non-limiting and is merely representative of various aspects and features of the present invention.

### Example 1

### Phase Composition of Calcium Silicate Powders

Tetraethyl orthosilicate (Si(OC₂H₅)₄, TEOS) and calcium nitrate (Ca(NO₃)₂.4H₂O) were used as precursors for SiO₂ and CaO, respectively, and nitric acid as catalyst. Ethanol was used as the solvent. The molar ratio of SiO₂/CaO is in the range of 7/3 to 3/7, as listed in Table 1. Various calcium silicate powders were synthesized by sol-gel method. The general procedure of sol-gel route, such as hydrolysis and aging, was adopted. Briefly, the TEOS was hydrolyzed with the sequential addition of 2 N HNO₃ and absolute ethanol for 1 hour stirring separately. The required amount of Ca(NO₃)₂.4H₂O was added to the above ethanol solution, and the mixed solutions were stirred for another 1 hour. The molar ratio of (HNO₃+H₂O):TEOS:ethanol was 10:1:10. The sol solution was sealed and aged at 60° C. for 1 day.

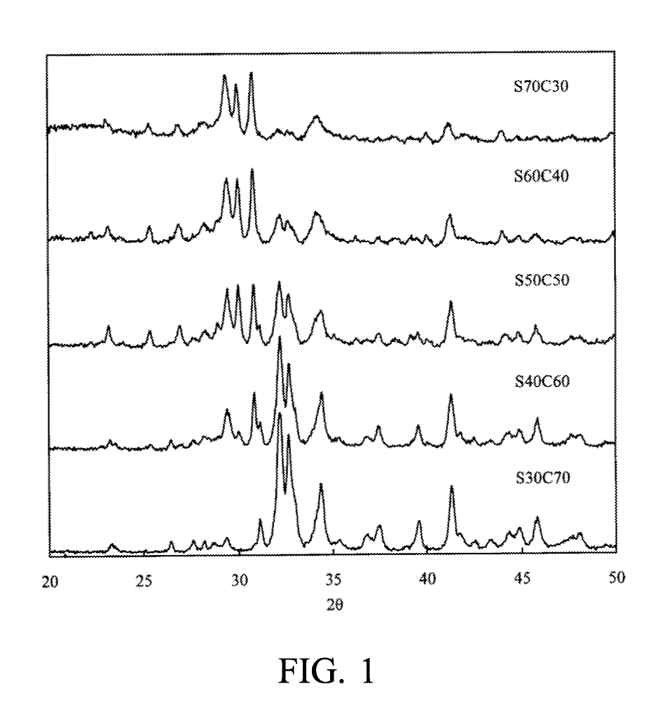

After solvent vaporization of the above-mentioned mixture solution in an oven at 120° C., the as-dried gel was heated in air to 900° C. for holding 1 hour, and then cooled to room temperature to produce various calcium silicate powders. Phase analysis was performed using Shimadzu XD-D1 X-ray diffractometer (XRD) with Ni-filtered Cukα radiation operated at 30 kV and 30 mA at a scanning speed of 1°/min. The XRD spectra of the various as-prepared CaO—SiO₂ powders are presented in FIG. 1. The diffraction maximum between 29 and 35° at 2θ can be attributed to different crystalline phases of calcium silicates, such as wollastonite and dicalcium silicate. A small amount of CaO at 2θ=37.5° appeared for the powders with silicon content lower than calcium such as S50C50, S40C60 and S30C70 specimens.

TABLE 1
Composition, setting time and diametral tensile strength of
SiO₂—CaO system cements after mixing with water or
ammonium hydrogen phosphate solution

| | | | | Ammonium hydrogen | |
|---|---|---|---|---|---|
| | Composition | Water | | phosphate | |
| | (molar ratio) | Setting | DTS | Setting time | DTS |
| Sample | SiO₂:CaO | time (min) | (MPa) | (min) | (MPa) |
| S70C30 | 7:3 | 76.3 ± 3.5 | 0.2 ± 0.0 | 9 ± 0.5 | 2.0 ± 0.2 |
| S60C40 | 6:4 | 28.6 ± 2.1 | 2.0 ± 0.3 | 7 ± 0.7 | 2.3 ± 0.1 |
| S50C50 | 5:5 | 30.0 ± 1.0 | 2.3 ± 0.2 | 5 ± 0.6 | 2.9 ± 0.2 |
| S40C60 | 4:6 | 21.7 ± 1.5 | 1.8 ± 0.4 | 4 ± 0.4 | 1.1 ± 0.1 |
| S30C70 | 3:7 | 10.0 ± 1.0 | 0.8 ± 0.2 | 3 ± 0.5 | 0.9 ± 0.1 |

### Example 2

### Setting Time and Diametral Tensile Strength of the Cement

The powders sintered at 900° C. for 1 hour were ball-milled using agate jars with agate grinding media in an ethanol medium for 24 hours with a Retsch centrifugal ball mill S 100. After drying, in order to prepare the cement, 0.2 g powder was mixed with water or the (NH₄)₂HPO₄—NH₄H₂PO₄ buffer solution (pH 7.4) using a liquid-to-powder (L/P) ratio of 0.5 to 0.7 mL/g depending on the kind of the cement. The setting times of the cements were tested using the 400-g Gillmore needle with a diameter of 1 mm according to the international standard ISO 9917-1 for water-based cements (ISO 9917-1, Dentistry-water-based cements part 1: powder/liquid acid-base cements. International Standard Organization, 2003). The setting time was recorded when the needle failed to create an indentation of 1 mm in depth in three separate areas. After mixing, the cement specimens were placed into a cylindrical stainless steel mould to form the specimen dimension of 6 mm (diameter)×3 mm (height), and stored in an incubator at 100% relative humidity and 37° C. for 1 day. The diametral tensile testing of cement specimens was conducted on an EZ-Test machine (Shimadzu, Kyoto, Japan) at a loading rate of 0.5 mm/min. The diametral tensile strength (DTS) value of the cement specimens was calculated from the relationship DTS=2P/πbw, where P is the peak load (Newton), b is the diameter (mm) and w is the thickness (mm) of the specimen. The maximal compression load at failure was obtained from the recorded load-deflection curves. At least ten specimens from each group were tested. Table 1 presents the results of setting times and DTS values of five calcium silicate cement specimens. When mixed with water, the setting time ranged from 10 to 76 minutes, significantly depending on the calcium silicate powders used. With the increase in the concentration of calcium component, the setting time of the cement became shorter. In contrast, all cement specimens hardened within 10 minutes after mixing with ammonium hydrogen phosphate solution. Regarding the DTS, the cement specimens with the greatest SiO₂ amount had a value of 2.0 MPa after mixing with ammonium hydrogen phosphate solution, whereas the greatest calcium amounts of cement specimens were measured at 0.9 MPa. The highest DTS value in the Ca—Si cement system was 2.9 MPa, recorded for the equilmolar Ca/Si ratio cement mixed with ammonium hydrogen phosphate solution.

### Example 3

### Effect of Sintering Temperature and Nitric Acid on Diametral Tensile Strength of the Cement

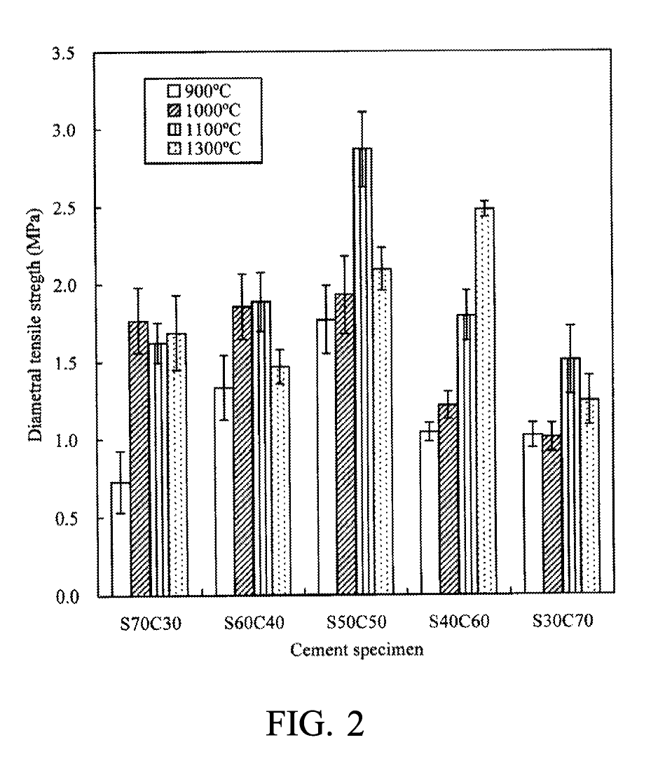

In the case of sintering temperature, the as-dried gel was heated in air to 900, 1000, 1100 and 1300° C. at a heating rate of 10° C./min and holding for 1 hour. Sequentially various as-sintered powders were ball-milled using agate jars with agate grinding media for 1 hour in a Retsch centrifugal ball mill S 100. After drying in an oven, the powders were mixed with the (NH₄)₂HPO₄—NH₄H₂PO₄ solution to measure DTS. FIG. 2 shows the effect of various sintering temperatures on DTS for five different calcium silicate materials. It should be noted that the lowest DTS value was measured for specimens sintered at 900° C., whereas the maximum value was dependent on the type of specimen obtained at different temperatures. The general trend was that the DTS values increased from 900 to 1100° C. To further understand processing parameters of a sol-gel route, the effect of nitric acid as catalyst on DTS was studied. The amount of nitric acid was replaced by pure water during sol-gel processing. The sintering temperature was 900° C. and the grinding time was 24 hours. The Ca/Si=5/5 cement prepared without nitric acid had a lower strength of 2.2±0.2 MPa than that of 2.9±0.2 MPa obtained for the cement with the addition of nitric acid.

### Example 4

### Effect of Grinding Time on Diametral Tensile Strength and Morphology of the Cement

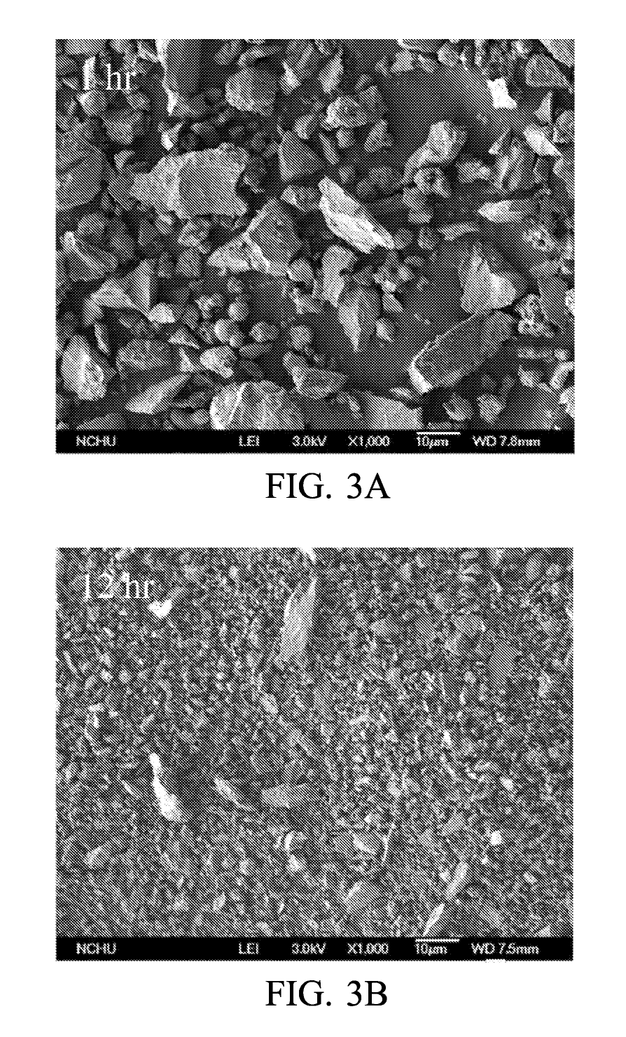

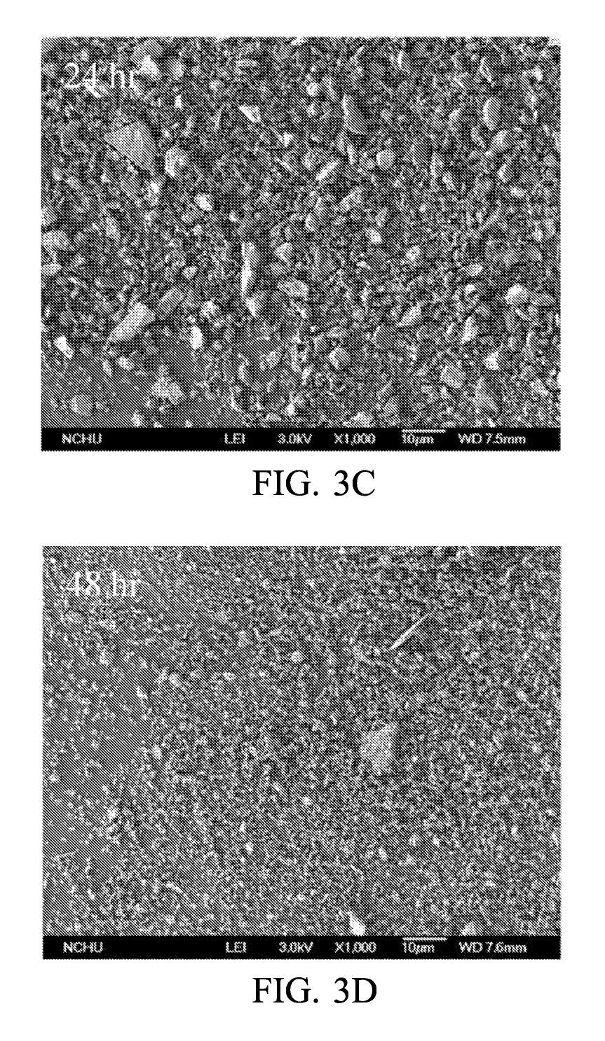

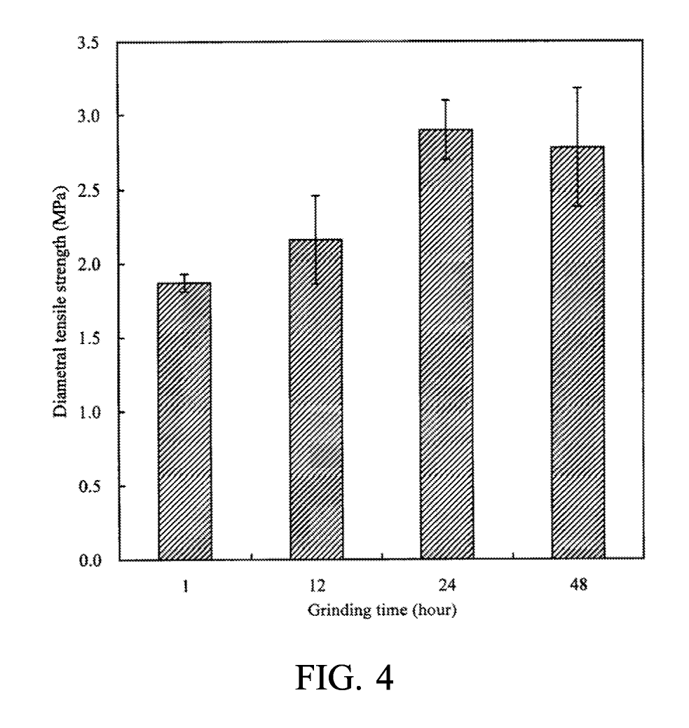

As for the effect of grind time, four different periods of time were applied for Ca/Si=5/5 powders sintered at 900° C. The powder morphology was studied as a function of milling time by JEOL JSM-6700F field emission scanning electron microscope (SEM). For 1 hour of grinding, the milled powders were formed of small irregular particles, ranging from 1 to 20 μm (FIG. 3). As a general trend, no spectacular changes in morphology were observable for grinding times of greater than 12 hours, except for a slight tendency to grind down to less than 1 μm. The relation of grinding time and DTS of the cement specimens was also evaluated. The ammonium hydrogen phosphate buffer solution was used as a liquid phase. The DTS values of the cements increased with increasing grinding time up to the optimum time of 24 hours (FIG. 4).

### Example 5

### Phase Composition of the Cement

XRD was used to analyze the phase composition of the hardened cement specimens. When the liquid phase of ammonium hydrogen phosphate was added to the calcium silicate powders, the product of the hydration process was apatite in combination with a calcium silicate hydrate (CaO—SiO₂—H₂O, C—S—H) gel, as shown in FIG. 5.

### Example 6

### Morphology of the Cement after Immersion in Physiological Solution

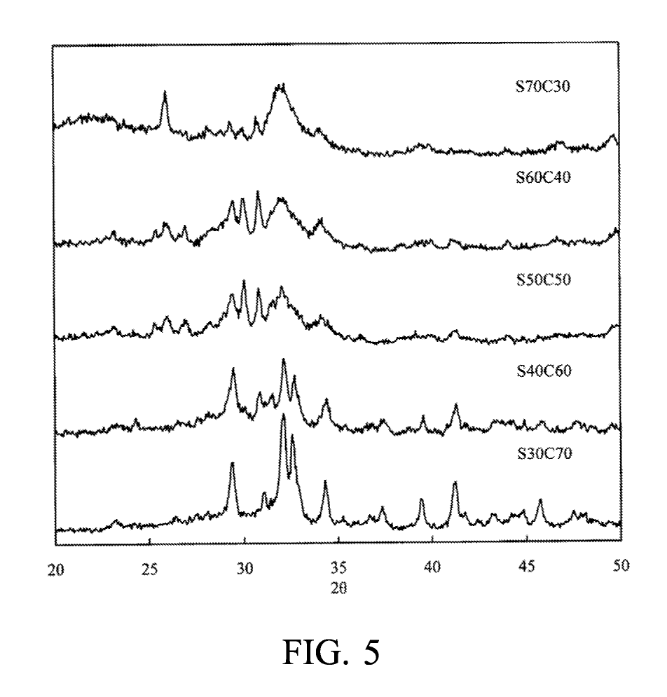

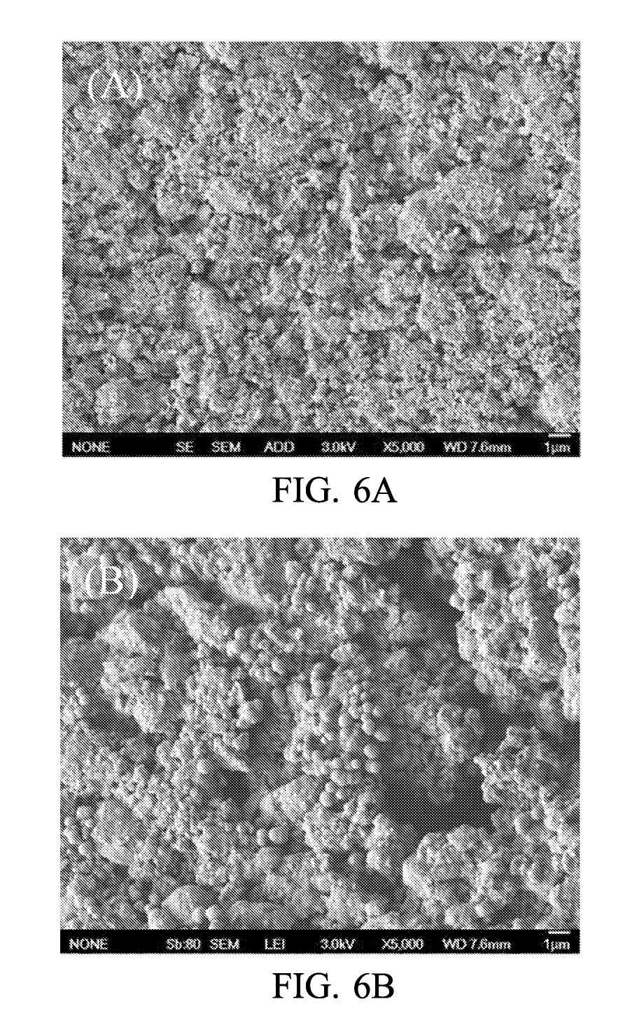

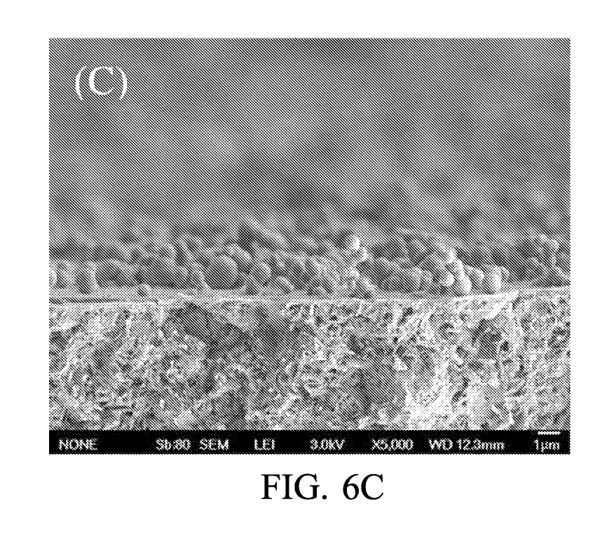

After mixing with ammonium hydrogen phosphate solution, each hardened specimen that was stored in an incubator at 100% relative humidity and 37° C. for one day was immersed in physiological solution for the predetermined periods of time at 37° C. to evaluate the cement bioactivity. The extracellular Hanks' solution (Pourbaix M. Electrochemical corrosion of metallic biomaterials. Biomaterials 1984; 5:122-134) with an ionic composition similar to that of human blood plasma was used as immersion solution. This solution consisted of 8.00 g NaCl, 0.35 g NaHCO₃, 0.40 g KCl, 0.06 g KH₂PO₄, 0.10 g MgCl₂.6H₂O, 0.14 g CaCl₂, 0.06 g Na₂HPO₄.2H₂O, 0.06 g MgSO₄.7H₂O, and 1.00 g glucose in 1000 ml distilled H₂O and had an initial pH of 7.4. The solution was in a shaker water bath and was not changed daily. After immersion, the specimens were removed from the vials to observe morphologies using an SEM. FIG. 6 indicates that the present cement with equilmolar Ca/Si ratio induced the formation of apatite spherulites, indicating the bioactivity, when immersed in physiological solution for as little as 1 hour.

### Example 7

### Diametral Tensile Strength for Various Immersed Cements

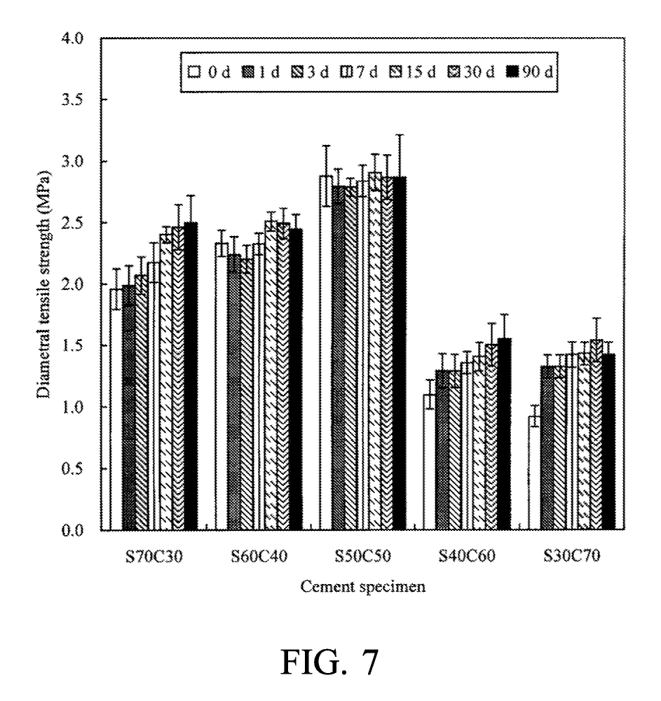

After immersion in Hanks' solution for different periods of time, the specimens were removed from the vials and subjected to tensile testing using an EZ-Test machine. At least ten specimens from each group were tested. The DTS of all immersed cement specimens generally did not decrease with increased immersion time (FIG. 7).

### Example 8

### Phase Composition of Immersed Cements

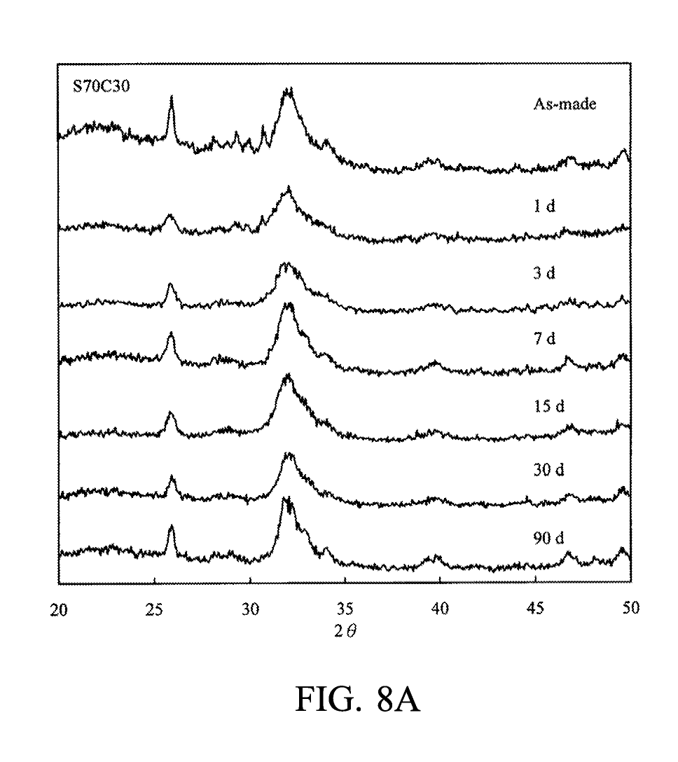

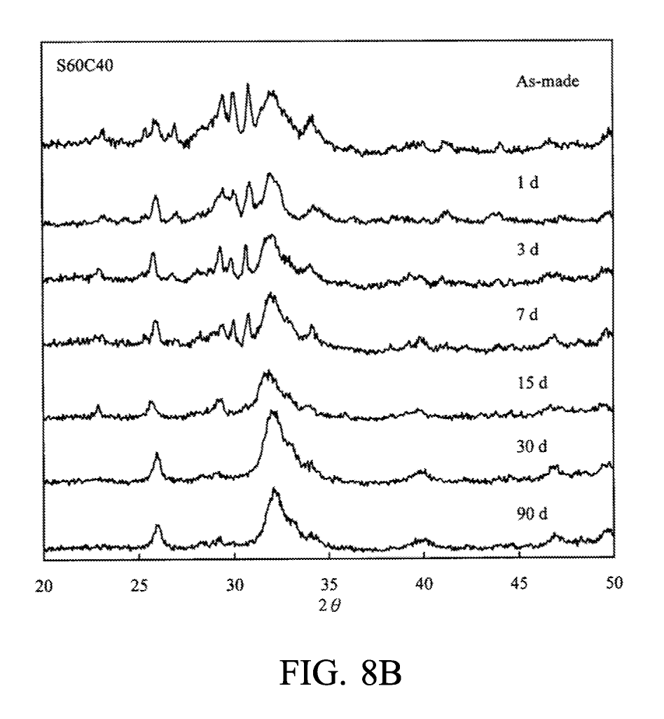

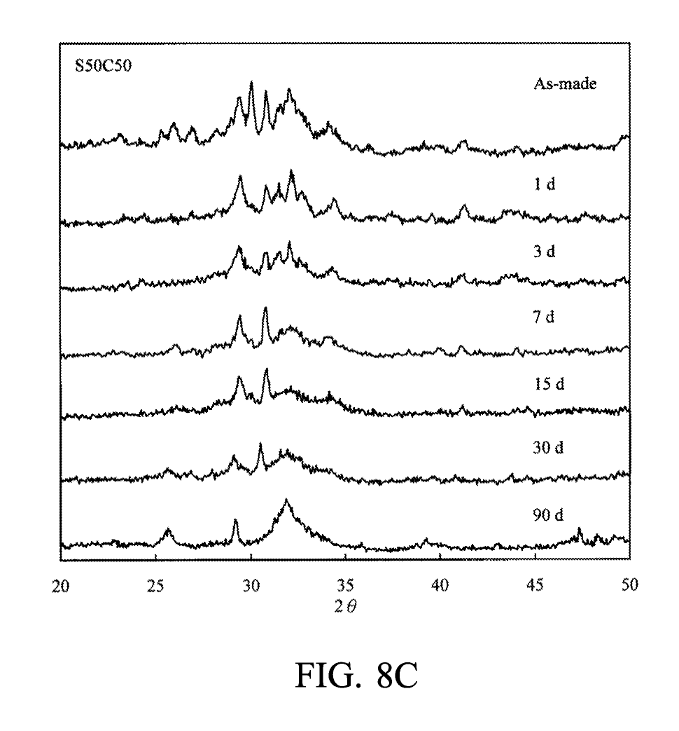

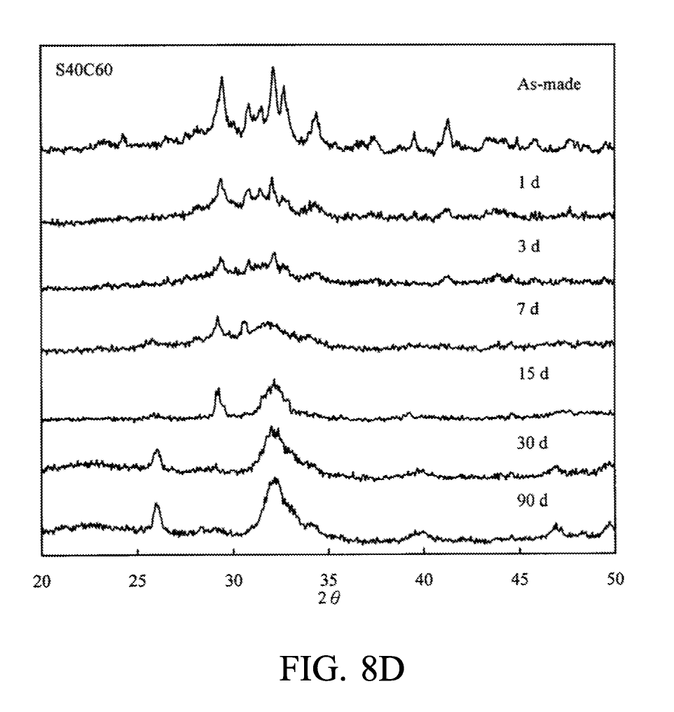

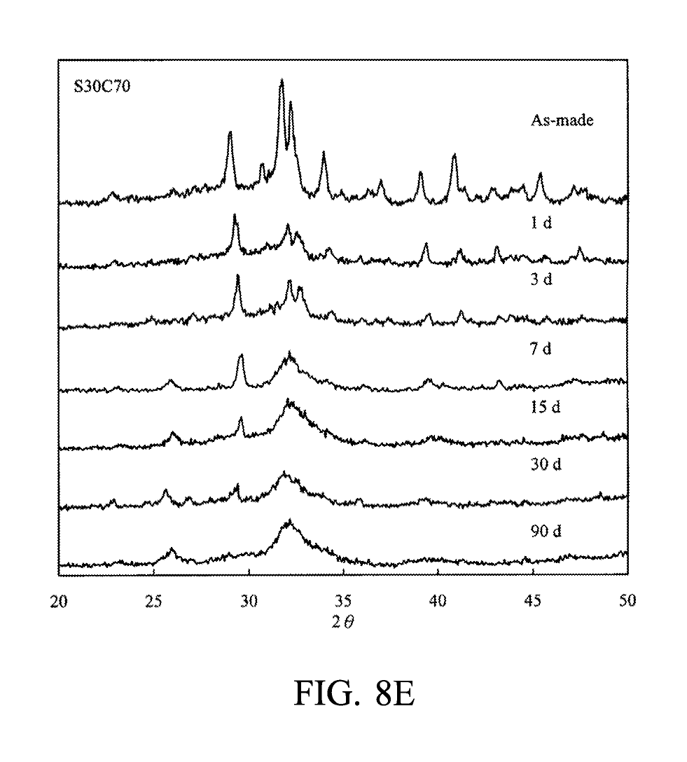

After immersion in Hanks' solution for a period of time, the specimens were removed from the vials. The phase evolution of the immersed cement specimens was carried out using an XRD. The intensities of the predominant phases with sharp peaks at 2θ=30-35° and the calcium silicate hydrate in all as-made cement decreased with increasing immersion time when immersed in simulated physiological solution (FIG. 8). The broadening of major apatite peaks roughly between 31 and 34° (2θ) indicated an immersion-induced precipitation of an amorphous apatite phase. The XRD results showed that the five calcium silicate cements had good bioactivity when soaked in simulated physiological solution.

### Example 9

### Morphology of Cell

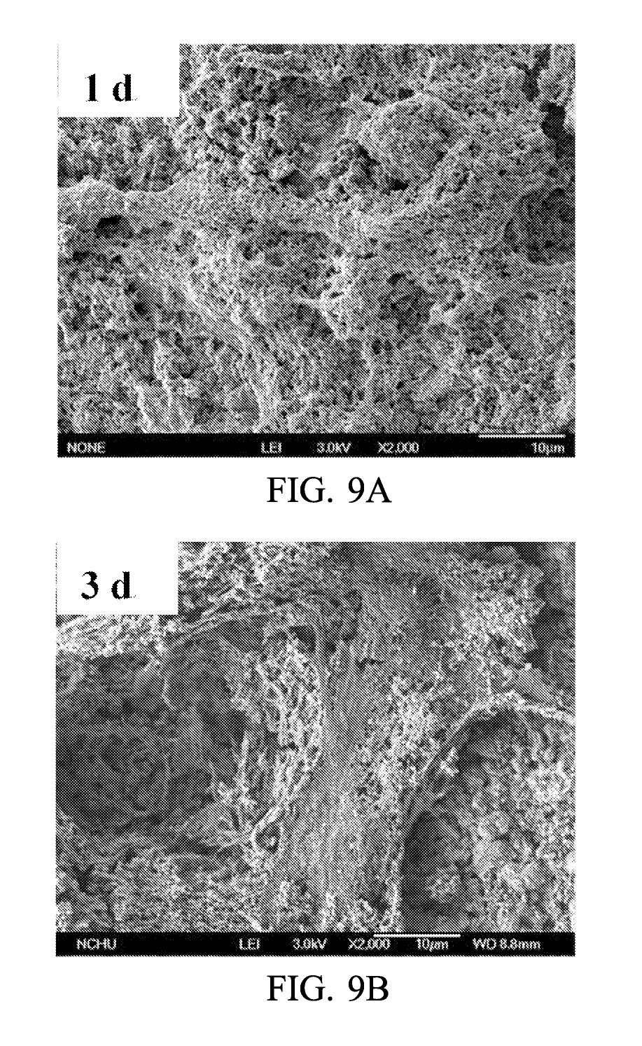

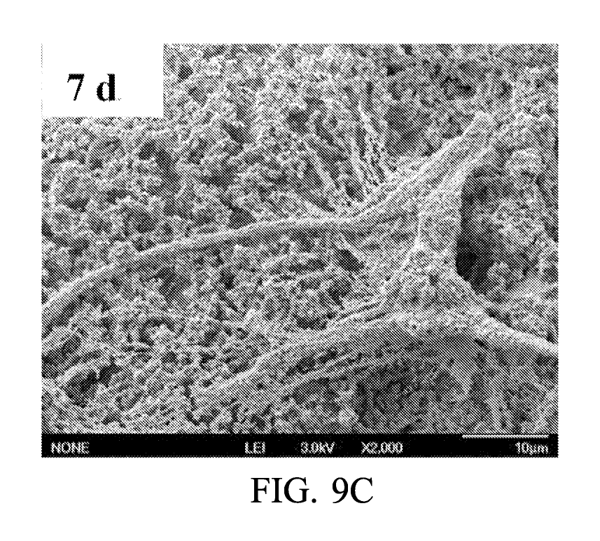

Cement biocompatibility was evaluated by incubation with human osteosarcoma cell line U2OS (ATCC, HTB 96, Manassas, Va., USA). Sample-free cultures were used as controls. For cell culture, the 1-day setting cement discs were sterilized by soaking in 75% ethanol and exposure to ultraviolet (UV) light for 2 hours. Single cell suspensions of U2OS were seeded into wells of a 24 well plate containing test specimen at 1×10⁴ cells per well and grown in McCoy's medium (Sigma) supplemented with 10% fetal bovine serum (FBS) and 1% antibiotics-antimycotic. Cultures were incubated at 37° C. in a 5% CO₂ atmosphere for 1, 3 and 7 days. After incubation, specimens were washed by phosphate buffer solution three times and fixed with 2% glutaraldehyde for 3 hours. Then the cements were dehydrated in a graded ethanol series for 20 minutes at each concentration and dried by liquid CO₂ using a critical point dryer device (LADD 28000, LADD, Williston, Vt.). The dried specimens were mounted on stubs and coated with gold layer. The cell morphology on the cement surface was observed using JEOL JSM-6700F SEM. The evaluation of SEM images confirmed that cells appeared to have firmly anchored on the cement surfaces that had an equilmolar Ca/Si ratio (FIG. 9).

### Example 10

### Evaluation of Cell Viability

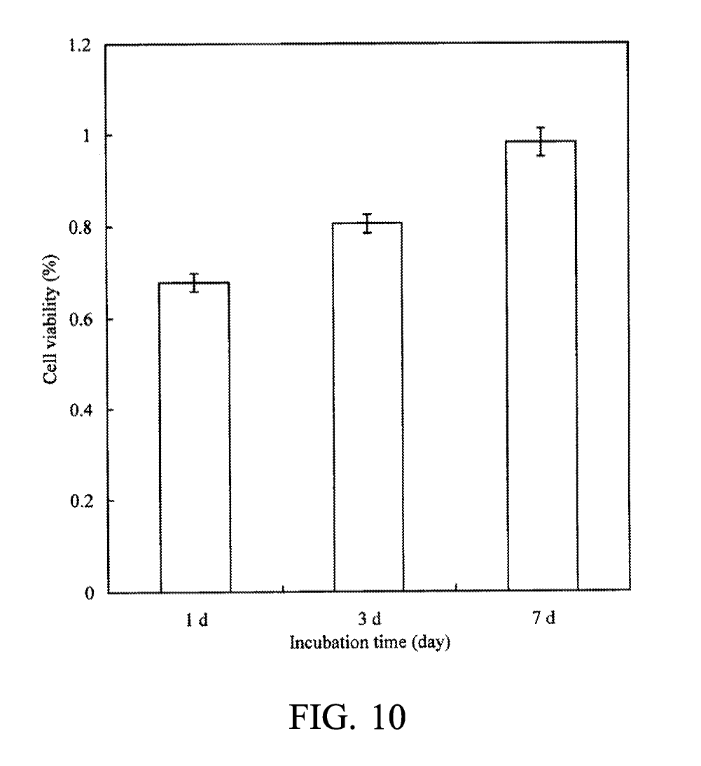

To quantitatively evaluate cell viability, MTT (3-(4,5-dimethylthiazol-2-yl)-2,5-diphenyltetrazolium bromide) in vitro toxicology assays were performed by adding reconstituted 2 mL MTT to each U2OS cell well containing test cement specimen. After incubation for 4 hours, 2 mL of DMSO was also added to each well. The plates were then shaken until the purple crystals had dissolved, and the solution in each well was transferred to a 96-well tissue culture plate. The absorbance at 570 nm was read with a Σ960 ELISA microplate reader (Metertech Inc, Taipei, Taiwan). Cell viability (%) was obtained by dividing the value of the cement specimen by that of the control one without cement specimen. In FIG. 10, MTT assay shows that the number of viable cells increased with an increased incubation, indicating a good biocompatibility.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for producing calcium silicate-based bone cement, comprising the steps of:
mixing calcium salt with silicohydrides to form a first mixture;
processing the first mixture with a sol-gel process to form a second mixture;
heating the second mixture to form a dried mixture;
grinding the second mixture into powder; and
adding the powder to water or phosphate solution.

2. The method of claim 1, wherein the calcium salt includes calcium nitrate.

3. The method of claim 1, wherein the silicohydride has the following formula: 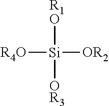
wherein R₁, R₂, R₃ and R₄ are C₁₋₆ alkyl group.

4. The method of claim 3, wherein R1, R2, R3 and R4 are C₂H₅.

5. The method of claim 1, wherein first mixture has a molar ratio of calcium to silicon ranging from 10 to 0.1.

6. The method of claim 1, wherein the first mixture has a molar ratio of calcium to silicon ranging from 4 to 0.25.

7. The method of claim 1, wherein the sol-gel process comprises the steps of:
mixing the first mixture with ethanol and/or dilute nitric acid;
performing a thermal treating process at a temperature between 20 and 80° C.; and
performing a drying process at a temperature between 100 and 150° C.

8. The method of claim 1, wherein the heating process comprises the following steps:
heating the second mixture to a temperature between 700 and 1300° C. at the rate of 1 to 40° C./min; and
performing a thermal treating process at a constant temperature between 700 and 1300° C.

9. The method of claim 1, wherein the grinding process comprises the steps of:
mixing the calcium silicate powder with alcohol;
grinding the powder with a ball miller; and
drying the powder at a temperature between 100 and 150° C.

10. The method of claim 9, wherein the particle size of the powder ranges from 0.01 to 50 micrometers.

11. The method of claim 10, wherein the particle size of the powder ranges from 0.1 to 5 micrometers.

12. The method of claim 1, wherein the ratio of the water to the powder is between 0.3 and 2 mL/g.

13. The method of claim 12, wherein the ratio of the water to the powder is between 0.4 and 0.7 mL/g.

14. The method of claim 1, wherein the ratio of the phosphate solution to the powder is between 0.4 and 2 mL/g.

15. The method of claim 1, wherein the ratio of the phosphate solution to the powder is between 0.5 and 0.8 mL/g.

16. The method of claim 1, wherein the phosphate solution includes phosphate radical (PO₄³⁻), monohydric phosphate radical (HPO₄²⁻) or dihydric phosphate radical (H₂PO₄⁻).

17. The method of claim 1, wherein the phosphate solution includes ammonium or a member of group IA.

18. The method of claim 1, wherein the phosphate solution includes ammonium, sodium or potassium.

19. The method of claim 1, wherein the phosphate solution includes anions with a concentration between 0.12 and 5 M.
